(19) United States
(12) Patent Application Publication
(10) Pub. No.: US 2002/0020615 A1
(43) Pub. Date: Feb. 21, 2002

(54) Axial-compression spring electrical contact having an impervious connection

(75) Inventor: Didier Bienvenu, Champigny-Sur-Marne (FR)

Correspondence Address: GREENBLUM & BERNSTEIN, P.L.C., 1941 ROLAND CLARKE PLACE, RESTON, VA, 20191, US

(73) Assignee: Societe d' Exploitation des Procedes Marechal (SEPM) Societe anonyme

(21) Appl. No.: 09/884,926

(22) Filed: Jun. 21, 2001

(30) Foreign Application Priority Data
Jun. 22, 2000 (FR) 0008006

(51) Int. Cl. H01H 1/06

(52) U.S. Cl. 200/275

(57) ABSTRACT

The invention relates to an axial-compression spring electrical contact having an impervious connection, adapted to be housed in a guiding shaft open at its two ends, arranged in an apparatus to be equipped and including a movable contact head connected to a terminal for connecting a feeding cable by a deformable conductor, the contact head being biased by a helical spring working in compression which surrounds the deformable conductor and takes support, at each of its ends, on the contact head and on a retaining element, respectively, which retaining element is housed in the bottom of the guiding shaft and is fixed to the deformable conductor. The contact is characterized in that at least one tubular gasket is immobilized in the bottom of the guiding shaft, extends through this bottom and surrounds the connecting terminal, at least partially, so as to encircle the outer sheath of the feeding cable.

### CROSS-REFERENCE TO RELATED APPLICATIONS

The instant application is based upon the French priority Patent Application No. 00 08006, filed Jun. 22, 2000, the disclosure of which is hereby expressly incorporated by reference thereto, and the priority of which is hereby claimed under 35 U.S.C. §119.

### BACKGROUND OF THE INVENTION

1. Field of the Invention

The present invention relates to an axial-compression spring electrical contact having an impervious connection.

2. Background and Material Information

The axial-compression spring electrical contacts are well known and frequently used, in particular, to equip surface sockets or a coupler socket.

They each have an element, or contact head, which is subject to translations of a certain amplitude in a guiding shaft provided in an insulating portion of the apparatus to be equipped, and which, therefore, must be connected to a terminal for connecting a feeding cable by a deformable conductor.

The contact head is adapted to elastically engage, under the action of a helical spring, with an opposing contact that is rigid, or also elastic, and arranged, for example, in a plug or an appliance inlet. The aforementioned helical spring, which is housed in the guiding shaft and works in compression, surrounds the deformable conductor and takes support, at each of its ends, on a bearing surface of the connecting terminal and a bearing surface of the contact head, respectively.

The known electrical contacts of this type use, as a deformable conductor, a metallic braid which can be deformed by compression.

However, it is readily understood that in this type of contact, the terminal for connecting the feeding cable cannot itself ensure imperviousness at the level of this connection.

To ensure the imperviousness of a certain volume, it is known to fill it with a liquid material that can be polymerized.

However, this process is long and requires expensive implementing machines and materials.

In addition, the materials are often perishable, dangerous, and their high densities lead to a heavy final product.

Moreover, such a process generates constraints during the design of the zones to be sealed, with all the drawbacks, in addition to those mentioned hereinabove, that can result therefrom, such as the incorrect filling of the zones and burrs dues to substantial clearances between the pieces in the zones to be sealed, etc.

### SUMMARY OF THE INVENTION

This is why, to render the connection impervious, without requiring the aforementioned process, the invention proposes an axial-compression spring electrical contact having an impervious connection, adapted to be housed in a guiding shaft open at its two ends, arranged in an apparatus to be equipped, and including a movable contact head connected to a terminal for connecting a feeding cable by a deformable conductor, the contact head being biased by a helical spring working in compression which surrounds the deformable conductor and takes support, at each of its ends, on the contact head and on a retaining element, respectively, which retaining element is housed in the bottom of the guiding shaft and is fixed to the deformable conductor. The contact is characterized in that at least one tubular gasket is immobilized in the bottom of the guiding shaft, extends through this bottom and surrounds the connecting terminal, at least partially, so as to encircle the outer sheath of the feeding cable.

In addition to eliminating the aforementioned drawbacks, it is understood that the contacts can be prepared and arranged in the apparatus in advance, and then connected to the gaskets by using conventional tools, whereas the gaskets, which are compact, concurrently ensure an electrical insulation between the various contacts.

Advantageously, the gasket has an annular lip arranged between the retaining element, or a portion connected thereto, and the bottom of the guiding shaft, such that an axial pressure from the helical spring is exerted on the lip and, according to one embodiment, the retaining element fixed to the deformable conductor includes at least one washer that is supported on the annular lip of the gasket.

In the known conventional contacts, the retaining element constitutes the terminal for connecting to the electric feeding cable.

However, according to a quite particular and advantageous embodiment making it possible to also ensure a connection that can be oriented in order to facilitate the positioning of the feeding cable in the apparatus to be equipped, which is particularly advantageous when the cable is rigid or semi-rigid and non-coaxial upon contact, the retaining element is a sleeve which is fixed to the deformable conductor and is crossed by an extension of the deformable conductor at the end of which the terminal for connecting to the electric feeding cable is arranged, such that the terminal can be oriented due to the flexibility of the deformable conductor.

One understands the increased advantage of the gasket according to the invention for this type of embodiment, since one obtains an adjustable connection which can be impervious or electrically insulated.

To complete the imperviousness, the contact head can be further provided with an O-ring joint.

As mentioned previously, the deformable conductor, which can be of any type, is generally in the form of a braid which can be deformed by compression.

### BRIEF DESCRIPTION OF DRAWINGS

The invention will be well understood upon reading the description that follows, with reference to the annexed drawings, in which:

FIG. 1 shows in cross-section a portion of a coupler socket, provided with at least one contact according to the invention,

FIG. 2 corresponds to FIG. 1, the contact here further having a connection that can be oriented according to a particular embodiment.

### DETAILED DESCRIPTION OF THE PREFERRED EMBODIMENTS

The Figures partially show an apparatus A to be equipped which, here, is a coupler socket provided with at least one contact 1 according to the invention.

Of course, the coupler socket shown is provided by way of example, and it could also be a surface socket.

The contact 1 is arranged in an insulating housing or guiding shaft 2, which is also called the contact support, provided in the apparatus A, the guiding shaft being open at its two ends.

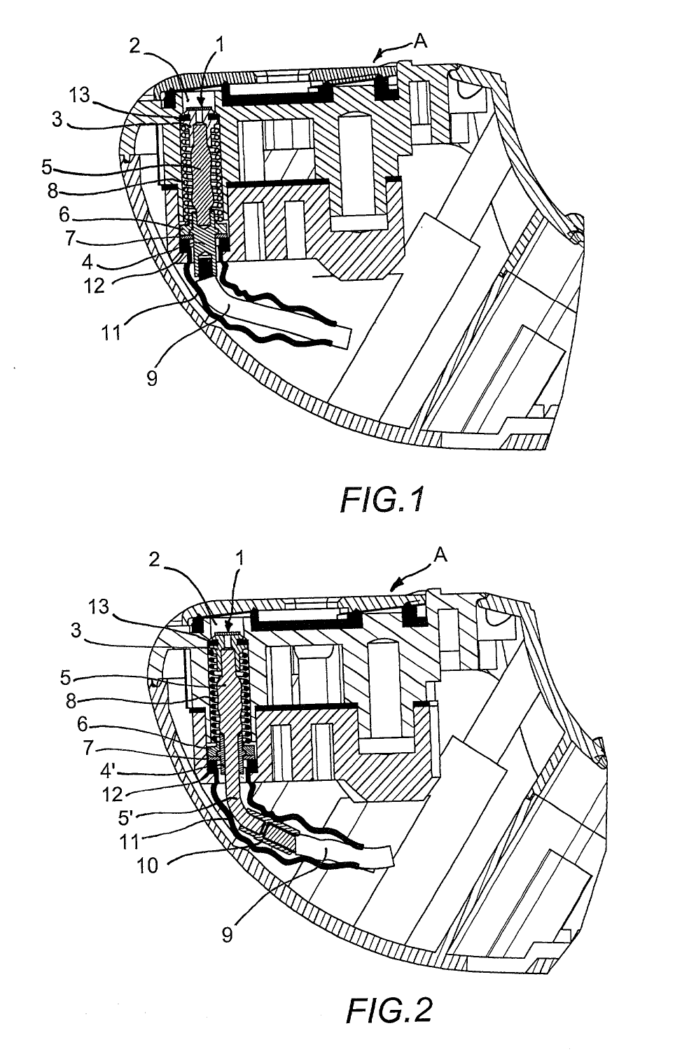

The contact 1 includes a contact head 3 mounted so as to move longitudinally in the guiding shaft 2. As shown in the drawings, the contact head is retained in the shaft 2 by a narrowing of the latter, and it is electrically connected to a retaining element 4 (FIG. 1), 4′ (FIG. 2), arranged in the bottom of the guiding shaft 2, by a conducting braid 5 that can be deformed by compression.

The retaining element here further includes two washers 6, 7, the upper washer 6 being slit for assembly and manufacture purposes.

A helical spring 8 working in compression is arranged around the braid 5 between a bearing surface of the contact head 3 and the upper washer 6 of the retaining element 4.

In this way, it is understood that the spring 8 biases the contact head 3 in the position shown, i.e., toward the corresponding opening of the guiding shaft 2, the contact head being provided as mentioned previously to elastically engage, due to the spring 8, with an opposing contact not shown.

Such a contact is of course provided to be connected to an electric feeding cable arranged in the apparatus, such as the cable 9 shown.

In the embodiment of FIG. 1, the retaining element 4 conventionally constitutes a connecting terminal for the cable 9, the terminal being fixed on the braid 5, for example, by crimping or soldering.

In the particular embodiment of FIG. 2, the connection can be oriented and, to this end, the retaining element 4′ is a sleeve that is also crimped or soldered on the braid 5, and the braid has an extension 5′ that extends through the sleeve 4′ and comes out of the guiding shaft 2, whereas it is the end of the extension 5′ of the braid that is provided with a terminal 10 for connecting to the cable 9, such that the terminal 10 can be oriented due to the flexibility of the braid.

The connecting terminals 4 or 10 are provided with any appropriate means to ensure the connection, such as a tightening screw or the like, short of a connection by crimping or soldering.

Therefore, to seal and/or insulate the connection of the contact, the invention provides a flexible tubular gasket 11 provided with a lip 12.

The lip 12 is arranged between the lower washer 7 of the retaining element 4, 4′ (connecting terminal 4 according to FIG. 1, or sleeve 4′ according to FIG. 2) and the bottom of the guiding shaft 2.

The gasket 11 partially surrounds the retaining element 4, 4′, as well as the extension 5′ of the braid 5 and the connecting terminal 10 in the case of the embodiment of FIG. 2; it then encircles the outer sheath of the feeding cable 9.

In this last embodiment, the extension of the braid is thus protected.

It is readily understood that the lip 12 of the gasket 11 is compressed by the effect of the spring and thus ensures the desired imperviousness.

To complete this imperviousness, the contact head 3 further includes an O-ring joint 13, as shown in the drawings.

The gasket 11 is, for example, a single piece made of rubber, which can be rolled up advantageously to facilitate the connections, but it could also be made of a plurality of parts of various types.

An imperviousness is thus obtained between the insulator in which the guiding shaft is arranged and the outer sheath of the cable 9.

As mentioned previously, the gasket, with a small space requirement, not only ensures the aforementioned imperviousness, but also the electrical insulation from adjacent contacts.

1. Axial-compression spring electrical contact having an impervious connection, adapted to be housed in a guiding shaft open at its two ends, arranged in an apparatus to be equipped and comprising a movable contact head connected to a terminal for connecting a feeding cable by a deformable conductor, the contact head being biased by a helical spring working in compression which surrounds said deformable conductor and takes support, at each of its ends, on the contact head and on a retaining element, respectively, which retaining element is housed in the bottom of the guiding shaft and is fixed to the deformable conductor, wherein at least one tubular gasket is immobilized in the bottom of the guiding shaft, extends through said bottom and surrounds the connecting terminal, at least partially, so as to encircle the outer sheath of the feeding cable.

2. Electrical contact according to claim 1, wherein the gasket has an annular lip arranged between the retaining element, or a portion connected thereto, and the bottom of the guiding shaft, such that an axial pressure from the helical spring is exerted on said lip.

3. Electrical contact according to claim 2, wherein the retaining element fixed to the deformable conductor comprises at least one washer that is supported on the annular lip of the gasket.

4. Electrical contact according to claim 1, wherein the retaining element constitutes the terminal for connecting to the electric feeding cable.

5. Electrical contact according to claim 1, wherein the retaining element is a sleeve which is fixed to the deformable conductor and is crossed by an extension of said deformable conductor at the end of which the terminal for connecting to the electric feeding cable is arranged, such that said terminal can be oriented due to the flexibility of the deformable conductor.

6. Electrical contact according to claim 1, wherein the contact head is further provided with an O-ring joint.

7. Electrical contact according to claim 1, wherein the deformable conductor is in the form of a braid which can be deformed by compression.
